(19) United States
(12) Patent Application Publication
(10) Pub. No.: US 2026/0367655 A1
(43) Pub. Date: Nov. 19, 2026

(54) Voltage Regulator with Variable Resistance that Tracks Load Impedance

(71) Applicant: Apple Inc., Cupertino, CA (US)

(72) Inventors: John S. Prentice, Palm Bay, FL (US); Patrick J. Landy, Melbourne, FL (US)

(21) Appl. No.: 19/209,318

(22) Filed: May 15, 2025

(51) Int. Cl. G05F 1/52

(52) U.S. Cl. CPC G05F 1/52

(57) ABSTRACT

In disclosed embodiments, circuitry that enhances closed-loop stability includes voltage regulator circuitry, load circuitry, variable resistor circuitry, and monitor circuitry. The voltage regulator circuitry generates a regulated output voltage at an output node based on a high supply voltage and a low supply voltage. The load circuitry, having a varying impedance over a range of operating frequencies, operates based on the regulated output voltage. The variable resistor circuitry is coupled to the high supply node and an internal node of the voltage regulator circuitry such that a resistance of the variable resistor circuitry varies in response to variations in impedance of the load circuitry. The monitor circuitry is coupled to the output node and to a control terminal of the variable resistor circuitry. The monitor circuitry generates a voltage at the control terminal of the variable resistor circuitry that is related to electrical current at the output node.

### BACKGROUND

### Technical Field

This disclosure relates generally to improving stability of integrated circuits over a range of frequencies.

### Description of Related Art

Stable closed-loop operation of circuits has long been a circuit design objective. To maintain stability over a range of operating frequencies, circuits traditionally have included components designed to change the circuit's operating parameters over the range of frequencies at which the circuit operates. While stable operation is an important consideration in circuit design, other considerations also are important, such as power consumption and chip surface area allocated to the circuit's components.

### BRIEF DESCRIPTION OF DRAWINGS

FIG. 1 is a block diagram illustrating example circuitry configured to enhance closed loop stability through variable resistance that tracks load impedance, according to some embodiments.

FIG. 2 is a block diagram illustrating an example circuit with a variable resistance transistor, according to some embodiments.

FIG. 3 is a circuit diagram illustrating a detailed example of the circuitry of FIG. 2, according to some embodiments.

FIG. 4A is a block diagram illustrating an example circuit with a variable resistance transistor and monitor circuitry, according to some embodiments.

FIG. 4B is a block diagram illustrating an example two-stage circuit with monitor circuitry and a different positioning of the variable resistance, according to some embodiments.

FIG. 5 is a block diagram illustrating example monitor circuitry, according to some embodiments.

FIG. 6 is a circuit diagram illustrating a detailed example of the circuitry of FIGS. 4 and 5, according to some embodiments.

FIG. 7 is a chart illustrating example frequency response of disclosed voltage regulator circuitry, according to some embodiments.

FIG. 8 is a chart illustrating example phase margin of disclosed voltage regulator circuitry, according to some embodiments.

FIG. 9 is a flow diagram illustrating an example method, according to some embodiments.

FIG. 10 is a block diagram illustrating an example computing device, according to some embodiments.

FIG. 11 is a diagram illustrating example applications of disclosed systems and devices, according to some embodiments.

FIG. 12 is a block diagram illustrating an example computer-readable medium that stores circuit design information, according to some embodiments.

### DETAILED DESCRIPTION

In the context of modern semiconductor manufacturing technologies and constraints on area and power consumption, designing integrated circuits (e.g., voltage regulators) that operate stably over a given frequency range is challenging. For example, to compensate for the reduction in supply voltage demanded by low power applications and the decrease in transistor gain associated with device downscaling, multi-stage circuits may be implemented, with the result that the closed-loop response of these integrated circuits is degraded due to the presence of multiple poles. Additionally, while traditional stabilization techniques often involve inclusion, in the integrated circuit of resistors and capacitors, adding additional resistors and capacitors to the circuit design tends to increase temperature variation and reduce fabrication tolerance of these devices. To address the foregoing problem, modern integrated circuit designs may place active components in the signal path. Doing so, however, may increase the complexity and power consumption of the device and increase chip area relative to traditional techniques. Further, as the power state of load circuitry changes, the impedance of the load circuitry also changes; therefore, the voltage regulator circuitry should be configured to quickly adjust to provide appropriate levels of electrical current to satisfy the varying impedance while maintaining stability.

The present disclosure covers integrated circuit embodiments (e.g., voltage regulators) that implement variable resistance that varies with load impedance. The variable resistance may enhance the stability of the integrated circuit with limited increases in power consumption and circuit area relative to traditional techniques, e.g., due to being implementable outside a signal path. For example, as load impedance increases, a high frequency pole pair associated with components of the integrated circuit transition to lower frequencies. As the resistance of the variable resistance increases proportionally with an increase in the load impedance, a zero associated with the variable resistor may also transition to lower frequencies. In this manner, the phase margin of the integrated circuit may be advantageously increased, relative to traditional techniques.

In some embodiments, monitor circuitry is configured to control the variable resistance based on monitoring electrical current at the output of the voltage regulator. For example, the monitor circuitry may include an auxiliary pass transistor that is gate coupled with the pass transistor of the voltage regulator and an auxiliary voltage regulator, a gate of which is coupled to the output node. Electrical current at the drain of the auxiliary voltage regulator may be proportional in magnitude to the electrical current at the output node, which varies inversely with changes in load impedance.

The monitor circuitry may further include a current mirror to provide the electrical current at the drain of the auxiliary voltage regulator to a current-to-voltage converter of the monitor circuitry that is gate-connected to a variable resistance transistor. Accordingly, the magnitude of the electrical current at the output node, which varies inversely with load impedance, may control the gate-to-source voltage of the variable resistance transistor such that a resistance of the variable transistor varies directly with the load impedance. Monitor circuit techniques may advantageously enhance overall circuit stability by enabling a variable resistance to accurately track the load impedance, while facilitating flexibility in placement of the variable resistance transistor.

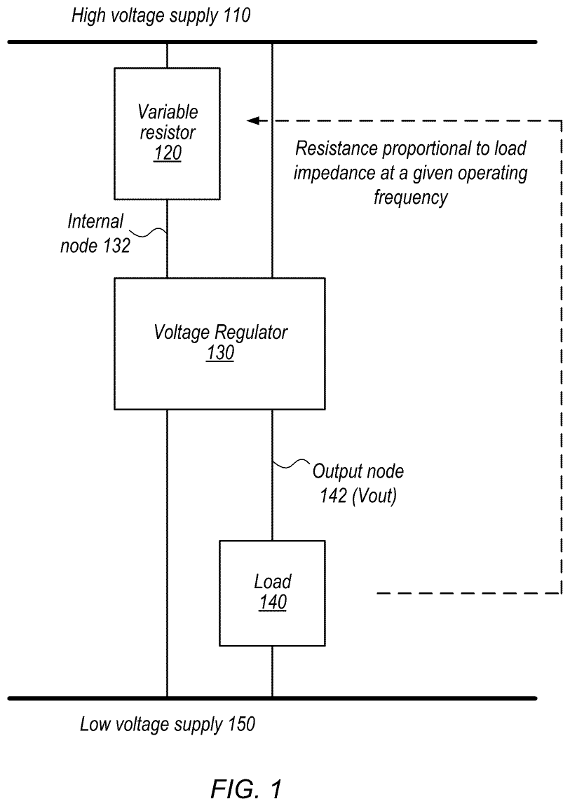

FIG. 1 is a block diagram illustrating example circuitry configured to enhance closed loop stability through variable resistance that tracks load impedance, according to some embodiments. The circuit of FIG. 1 is configured to provide a substantially consistent output voltage at an output node to a load, regardless of changes in the load impedance. By tracking a load impedance of the circuitry, a zero attributable to the variable resistance may follow a frequency response of poles introduced by components of the circuitry. In this manner, closed loop circuit stability may be enhanced.

In the illustrated example, a circuit operates based on high voltage supply 110 and low voltage supply 150. Additionally, the circuit includes variable resistor 120, voltage regulator 130, and load 140. Internal node 132 couples variable resistor 120 to voltage regulator 130, which is coupled to low voltage supply 150. Variable resistor 120 also is coupled to high voltage supply 110. Voltage regulator 130 is positioned between and coupled to load 140 via an output node 142 (Vout) and high voltage supply 110. At a given operating frequency, a resistance of variable resistor 120 is proportional to a load impedance of load 140.

Load 140 may be any circuitry, but, in some embodiments, load 140 corresponds to digital logic, such as a central processing unit (CPU) or a graphical processing unit (GPU). Accordingly, load 140 may quickly switch from a high power state to a lower power state or vice-versa in certain scenarios. Thus, the impedance of load 140 may quickly change, resulting in rapid fluctuations of output current at output node 142. Traditionally, such fluctuations could lead to instability and resulting poor regulation of output voltage at output node 142. In contrast, by dynamically adjusting resistance of variable resistor 120 in response to changes in impedance of load 140, the circuit advantageously may operate stably over a range of frequencies, resulting in more robust voltage regulation than traditional voltage regulators.

### Example Gate-Coupled Variable Resistance

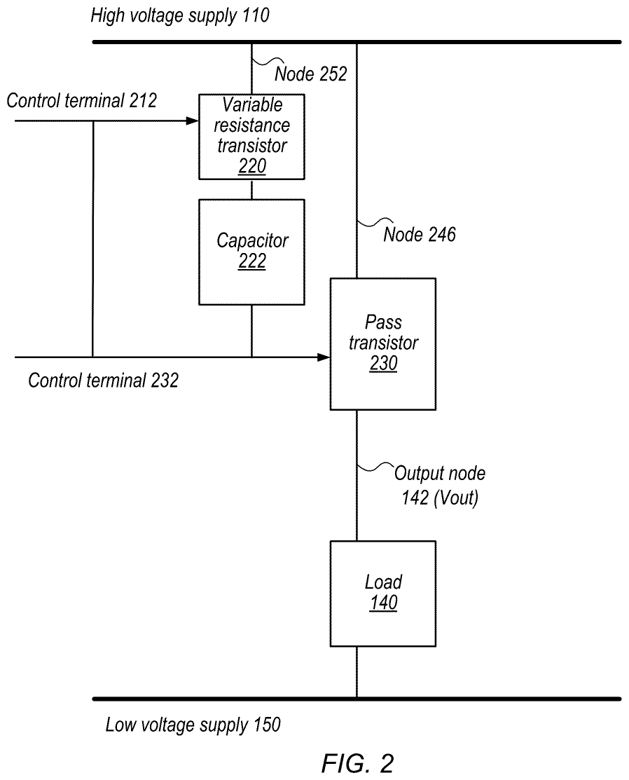

FIG. 2 is a block diagram illustrating an example circuit with a variable resistance transistor, according to some embodiments. Variable resistance transistor 220 and capacitor 222 are an example implementation of variable resistor 120. Pass transistor 230 is an example implementation or portion of of voltage regulator 130. In this example, the control terminals (e.g., gates) of transistor 220 and 230 are coupled and this coupling corresponds to internal node 132 of FIG. 1.

During operation, the magnitude of output electrical current at output node 142 varies inversely with a variation in an impedance of load 140. The voltage across control terminal 232 and node 246 varies directly with the variation in the magnitude of the output electrical current. Accordingly, the voltage across control terminal 212 and node 252 also varies directly with the variation in the magnitude of the output electrical current. The resistance of variable resistance transistor 220 varies inversely with the voltage across control terminal 212 and node 252. Thus, the resistance of variable resistance transistor 220 tracks the impedance of load 140.

Coupling control terminal 232 and control terminal 212 may advantageously enable resistance of variable resistance transistor 220 to rapidly adjust in response to changes in impedance of load 140. In this manner, closed loop stability of the circuit is enhanced even in response to rapid fluctuations in the impedance of load 140.

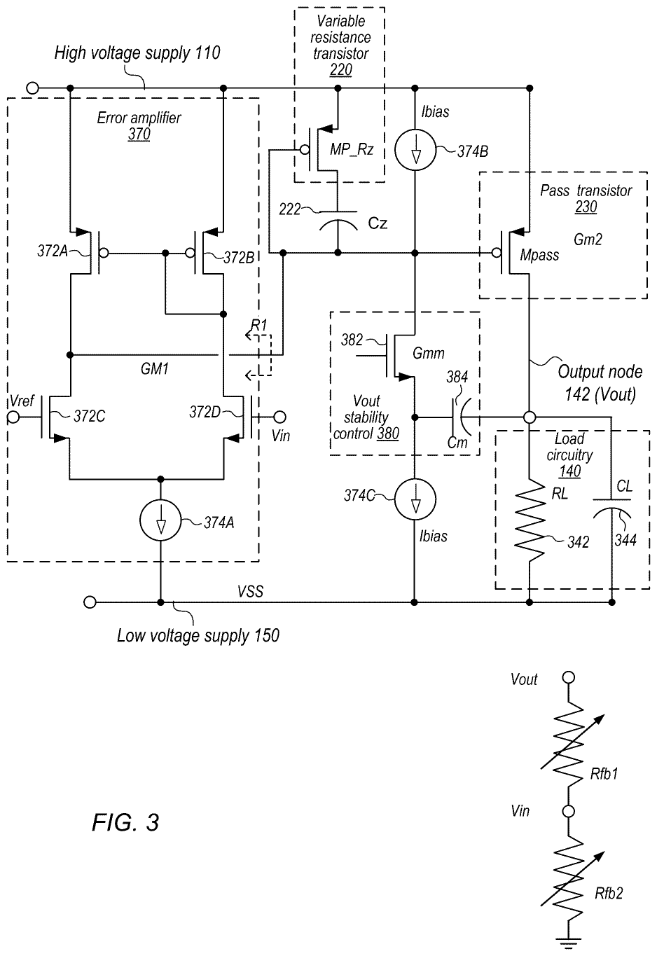

FIG. 3 is a circuit diagram illustrating a detailed example of the circuitry of FIG. 2, according to some embodiments. The circuit of FIG. 3 is a complementary metal-oxide-semiconductor (CMOS) implementation of the circuit of FIG. 2. It is understood, however, that other technologies may implement the functionality of FIG. 3. For example, the functionality of FIG. 3 is implementable using bipolar junction transistors (BJTs), bipolar CMOS (BICMOS), III-V semiconductor manufacturing technology, etc. While some transistors depicted in FIG. 3 are n-type metal-oxide-semiconductor (NMOS) transistors and other transistors are p-type metal-oxide semiconductor (PMOS) transistors, in other embodiments, the transistor types may be substituted with one another (e.g., NMOS used in lieu of PMOS, or some other transistor type substituted) with appropriate modifications to the circuit topology.

In the illustrated example, the circuit includes error amplifier 370, variable resistance transistor 220, Vout stability control 380, auxiliary biasing circuitry 374, pass transistor 230, and load circuitry 140, all positioned between high voltage supply 110 and low voltage supply 150. Auxiliary biasing circuitry 374 is a voltage controlled current source (and may be implemented using an NMOS transistor, for example). Pass transistor 230 regulates the voltage at output node 142 as the impedance of load circuitry 140 changes. Resistance of variable resistance transistor 220 changes directly with change in the impedance of load circuitry 140, thereby providing stability to the circuit over the range of frequencies at which the circuit operates.

Error amplifier 370 includes NMOS transistors 372C and 372D, PMOS transistors 372A and 372B, and biasing current source 374A. Error amplifier 370 is configured to provide a biasing voltage to gates of variable resistance transistor 220 and pass transistor 230.

Source terminals of transistors 372C and 372D are coupled to biasing current source 374A. In some embodiments, biasing current source 374A may be a voltage controlled current source (e.g., an NMOS transistor). Gate of transistor 372C is biased by a reference voltage (Vref) and gate of transistor 372D is biased by an input voltage (Vin). A drain of transistor 372C is coupled to the drain of transistor 372A and to the gate of pass transistor 230. Sources of transistors 372A and 372B are coupled to high voltage supply 110. The drain of transistor 372B is coupled to gates of transistors 372A and 372B which are coupled to one another. The biasing may be based on a difference between voltages Vin and Vref.

Pass transistor 230 is a PMOS transistor having its source coupled to high voltage supply 110 and its drain coupled to load circuitry 140 via output node 142. The gate of pass transistor 230 is coupled to error amplifier 370, the gate of variable resistance transistor 220, a terminal of capacitor 222, auxiliary biasing circuitry 374B, and the drain of NMOS transistor 382 that is a component of Vout stability control 380. Pass transistor 230 is configured to provide an output electrical current at output node 142 to load circuitry 140. Thus, pass transistor 230 is configured to convert an unregulated voltage (e.g., high voltage supply 110) to a regulated output voltage at output node 142.

Load circuitry 140 is modeled as a variable resistor 342 and a variable capacitor 344. The variable resistor 342 corresponds to a resistive component of load circuitry 140, and variable capacitor 344 corresponds to a capacitive component of load circuitry 140 in addition to decoupling capacitance(s). The impedance of load circuitry 140 may change drastically due, for example, to load circuitry 140 quickly (e.g., within milliseconds or less) transitioning from a high-power state to a low-power state. As the impedance of load circuitry 140 changes, the magnitude of the output electrical current at output node 142 also changes, thereby causing a change in the gate-to-source voltage of pass transistor 230.

Vout stability control 380 includes NMOS transistor 382 and Miller capacitor 384 having capacitance Cm. During operation, Vout stability control 380 enhances circuit stability while maintaining a power supply rejection ratio (PSRR) of the circuit (e.g., mitigating leakage of noise from high voltage supply 110 into the regulated voltage of output node 142).

The drain of NMOS transistor 382 is coupled to auxiliary biasing circuitry 374B, and the source of NMOS transistor 382 is coupled to auxiliary biasing circuitry 374C and to Miller capacitor 384, which is coupled to output node 142. Miller capacitor 384 performs a pole splitting function, thereby enhancing circuit stability over an operating frequency of the circuit. If, however, Miller capacitor 384 were coupled to the gate of pass transistor 230, as in some traditional implementations, Miller capacitor 384 would degrade the PSRR of the circuit such that noise from the unregulated voltage (e.g., high voltage supply 110) might infiltrate the regulated output voltage at output node 142. To mitigate degradation of PSRR, transistor 382 is coupled to Miller capacitor 384, which reduces noise leakage from high voltage supply 110 to output node 142. In this manner, the stability-enhancing features of Miller capacitor 384 are provided without introducing noise into output node 142. Auxiliary biasing circuitry 374B and 374C provide current for operation of transistor 382.

Variable resistance transistor 220 is a PMOS transistor having its source coupled to high voltage supply 110 and its drain coupled to capacitor 222. The gate of variable resistance transistor 220 is coupled to a terminal of capacitor 222, the drain of transistor 382, and to the gate of pass transistor 230. The magnitude of the output current at output node 142 changes directly with change in the impedance of load circuitry 140. The gate-to-source voltage of pass transistor 230 and variable resistance transistor 220 likewise change directly with the change in the magnitude of the output current. The resistance of variable resistance transistor 220 changes inversely with the change in the magnitude of the gate-to-source voltage of variable resistance transistor 220. Accordingly, the resistance of variable resistance transistor 220 changes directly with the change in the impedance of load circuitry 140.

FIG. 3 also shows a resistor feedback network that completes a feedback loop (instability occurs when the feedback loop is closed, although various open-gain analysis may be performed to predict closed-loop stability). In the illustrated example, the Rfb1 and Rfb2 resistors make up the feedback network, and similar feedback networks may be present in various other figures in closed-loop environments, even if not shown.

### Example Variable Resistance Based on Monitor Circuitry

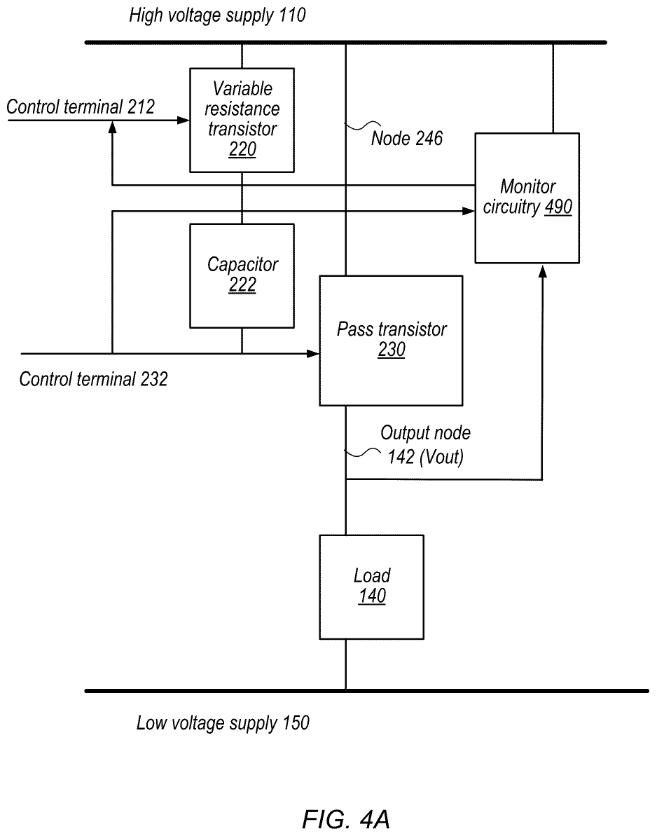

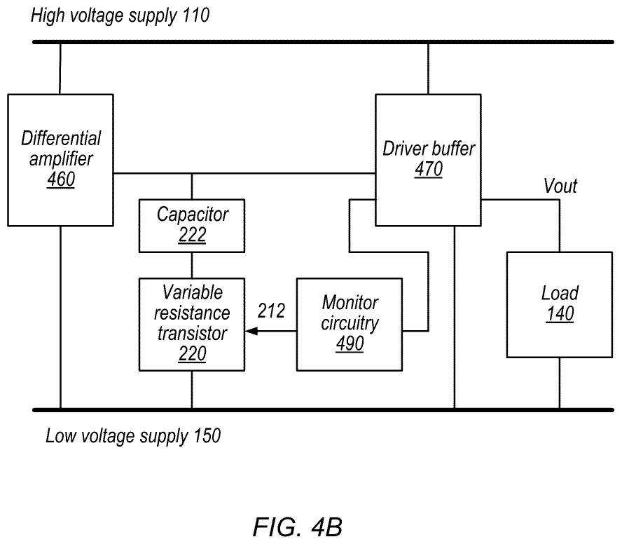

FIG. 4A is a block diagram illustrating an example circuit with a variable resistance transistor and monitor circuitry, according to some embodiments. In the illustrated example, the circuit includes variable resistance transistor 220, capacitor 222, pass transistor 230, load 140, monitor circuitry 490, and load 140. The resistance of variable resistance transistor 220 tracks the impedance of load 140 based on the voltage provided by monitor circuitry 490 to the control terminal of variable resistance transistor 220.

Monitor circuitry 490, in the illustrated embodiment, is coupled to control terminal 232, control terminal 212, and output node 142. During operation, the magnitude of the output electrical current at output node 142 varies inversely with the impedance of load 140. The voltage across control terminal 232 and node 246 is related to variance in the magnitude of the output current. Note that this relationship may be direct or inverse, may be a linear or non-linear relationship, etc. in different embodiments. Generally, the voltage across the control terminal 232 is based on the output current and varies in response to variations in the output current. The voltage is provided to monitor circuitry 490, which, in turn, provides the voltage to control terminal 212. The resistance of variable resistance transistor 220 varies inversely with the provided voltage. Accordingly, the resistance of variable resistance transistor 220 tracks the impedance of load 140.

As compared with the embodiment of FIG. 2, the embodiment of FIG. 4A may advantageously facilitate placement of variable resistance transistor 220 in different blocks of the circuit or, alternatively, on other circuits.

FIG. 4B is a block diagram illustrating an example circuit with a variable resistance transistor and monitor circuitry, according to some embodiments. In the illustrated example, the circuit includes load 140, capacitor 222, variable resistance transistor 220, differential amplifier 460, and driver buffer 470.

This is one example of a multi-stage LDO (two-stage in this example, with the differential amplifier 460 being the first stage and driver buffer 470 being a high-current second stage). This may be a flipped-voltage-follower (FVF) implementation, for example. Similarly numbered components may be configured as discussed above.

Differential amplifier 460, in some embodiments, is an error amplifier, e.g., corresponding to circuitry 370 of FIG. 3. The output of differential amplifier 460 is provided to driver buffer 470 to generate the regulated output voltage for the load. Monitor circuitry 490, in this embodiment, monitors characteristics of the driver buffer 470 to control the variable resistance transistor 220.

For example, monitor circuitry 490 may include an auxiliary pass transistor (e.g., auxiliary to a pass transistor in the driver buffer 470) configured to generate a current that is proportional to the load current. This auxiliary pass transistor's gate may be connected to the gate of the pass transistor of the driver buffer, for example, such that the auxiliary pass transistor monitors the current at the output node. Monitor circuitry 490 may mirror this load current (e.g., using a set of transistors configured as a current mirror) and use it to adjust the resistance of transistor 220. In this example, a current to voltage transistor may be gate-connected with the variable-resistance transistor such that the variable resistance becomes larger as the load current increases. Thus, the unity-gain bandwidth may move to a higher frequency as the variable resistance comes larger (which may improve LDO performance metrics such as load step settling time, relative to implementations without a variable resistance).

Therefore, FIG. 4B provides one example of a different location for the variable resistance (e.g., different relative to FIG. 3) where the flexibility is enabled by the monitor circuit implementation. Similar monitor circuitry may be implemented in multi-stage embodiments with various numbers of stages, in other topologies, etc.

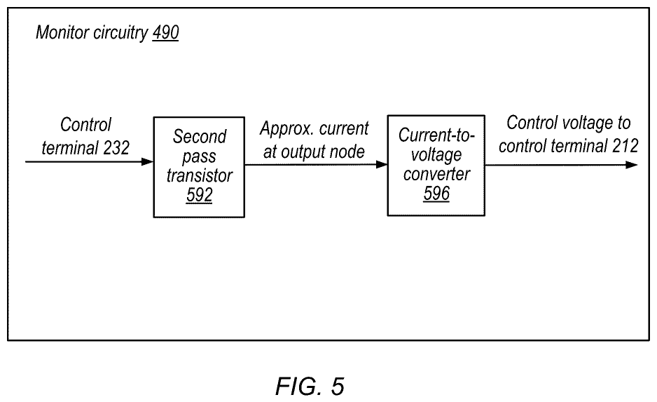

FIG. 5 is a block diagram illustrating example monitor circuitry, according to some embodiments. In the illustrated example, monitor circuitry 490 includes second pass transistor 592 and current-to-voltage converter 596. Second pass transistor 592 may be a CMOS transistor, but may be proportionally smaller than (e.g., have a smaller width-to-length ratio) transistor 230. In response to receiving the same control voltage as transistor 230 (e.g., via control terminal 232), second pass transistor 592 is configured to approximate a magnitude of an output electrical current at output node 142. For example, the approximate output electrical current may be proportionally smaller in magnitude than the output electrical current. Current-to-voltage converter 596 is configured to provide a control voltage to control terminal 212. The control voltage is based on the approximate output electrical current. The resistance of variable resistance transistor 220 varies inversely with the control voltage.

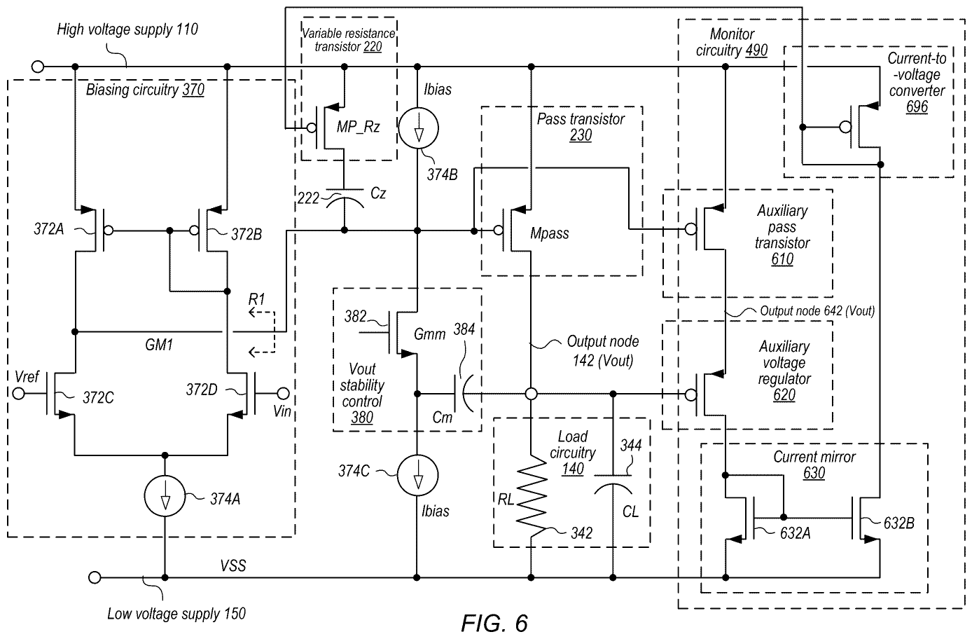

FIG. 6 is a circuit diagram illustrating a detailed example of the circuitry of FIGS. 4 and 5, according to some embodiments. The circuit of FIG. 6 is a complementary metal-oxide-semiconductor (CMOS) implementation of the circuit of FIGS. 4 and 5. It is understood, however, that other technologies may implement the functionality of FIG. 6. For example, the functionality of FIG. 6 is implementable using bipolar junction transistors (BJTs), bipolar CMOS (BICMOS), III-V semiconductor manufacturing technology, etc. While some transistors depicted in FIG. 6 are NMOS transistors and other transistors are PMOS transistors, in other embodiments, the transistor types can be substituted with one another (e.g., NMOS used in lieu of PMOS) with appropriate modifications to the circuit topology. Note that FIG. 6 may operate in a closed-loop scenario, e.g., incorporating the resistor feedback network shown in FIG. 3.

In the illustrated example, FIG. 6 includes error amplifier 370, variable resistance transistor 220, Vout stability control 380, auxiliary biasing circuitry 374, pass transistor 230, load circuitry 140, and monitor circuitry 490, all positioned between high voltage supply 110 and low voltage supply 150. Except that the gate of variable resistance transistor 220 is not coupled to the gate of pass transistor 230, various components such as error amplifier 370, variable resistance transistor 220, Vout stability control 380, auxiliary biasing circuitry 374, pass transistor 230, and load circuitry 140, may be configured as described with reference to FIG. 3.

Monitor circuitry 490, in the illustrated example, includes auxiliary pass transistor 610, auxiliary voltage regulator 620, current mirror 630, and current-to-voltage converter 696. Auxiliary pass transistor 610 is a PMOS transistor having its source coupled to high voltage supply 110 and its drain coupled to auxiliary voltage regulator 620. The gate of auxiliary pass transistor 610 is coupled to the gate of pass transistor 230. Auxiliary voltage regulator 620 is a PMOS transistor having its source coupled to the drain of auxiliary pass transistor 610 and its drain coupled to current mirror 630. A gate of auxiliary voltage regulator 620 is coupled to output node 142. Auxiliary voltage regulator 620 may have a threshold voltage that is close to its gate-to-source voltage. Some implementations of monitor circuitry 490 may lack auxiliary voltage regulator 620.

Current mirror 630 includes transistors 632A and 632B, which, as illustrated, are NMOS transistors. The gates of transistors 632A and 632B are coupled. Additionally, the gate of transistor 632A is coupled to the drain of auxiliary voltage regulator 620. Sources of transistors 632A and 632B are coupled to low voltage supply 150. Additionally, the drain of transistor 632B is coupled to the drain of current-to-voltage converter 696.

Current-to-voltage converter 696 is a PMOS transistor having its source coupled to high voltage supply 110 and its drain coupled to a drain of transistor 632B. Additionally, the drain of current-to-voltage converter 696 is coupled to the gate of current-to-voltage converter 696, which is coupled to the gate of variable resistance transistor 220.

During operation, based on a biasing voltage applied to auxiliary pass transistor 610 (which may be substantially the same biasing voltage as applied to pass transistor 230), an output current at output node 642 of auxiliary pass transistor 610 is proportional in magnitude to the output current at output node 142. In particular, the output current at output node 642 may be proportionally smaller in magnitude than the output current at output node 142 in accordance with the proportionally smaller dimensions of auxiliary pass transistor 610 relative to pass transistor 230. Auxiliary voltage regulator 620 is configured to maintain the magnitude of the output current at its drain such that the current provided to current mirror 630 remains proportional in magnitude to the output current at output node 142.

Current mirror 630 is configured to provide the output current propagated at the drain of auxiliary voltage regulator 620 to current-to-voltage converter 696. Current-to-voltage converter 696 is configured to convert the provided output current to a voltage that biases the gate of variable resistance transistor 220. Variable resistance transistor 220 is configured to vary its resistance 220 inversely with the provided biasing voltage. In this manner, the resistance of variable resistance transistor 220 tracks the impedance of load circuitry 140.

As discussed above, the monitor circuitry 490 facilitates flexible placement of variable resistance transistor, e.g., in other implementations such as the embodiment of FIG. 4B. Specifically, controlling the variable resistance transistor based on monitored characteristics may provide flexibility relative to implementations in which the variable resistance transistor is gate-connected with the pass transistor (e.g., as in FIG. 3).

The stabilizing effect of varying the resistance of variable resistance transistor 220 while varying impedance of load circuitry 140 may be understood based on the transfer equation corresponding to the circuits of FIGS. 3 and 6. The transfer equation is as follows:

$$\frac{{V}_{out}}{{V}_{in}} \approx \frac{{G}_{m 1} {R}_{1} {G}_{m 2} [ \frac{{SC}_{m} + {G}_{mm} ]}{{G}_{mm}}}{{D}_{s}} \frac{[ {SC}_{z} {R}_{Z} + 1 ]}{1}$$

$$where$$

$${D}_{s} = {s}^{3} [ \frac{{C}_{L} {C}_{m} {C}_{z} {R}_{L} ( {R}_{1} + {R}_{z} )}{{G}_{mm}} ] + {s}^{2} [ {C}_{m} {C}_{z} {G}_{m 2} {R}_{L} {R}_{1} {R}_{z} + \frac{{C}_{L} {C}_{m} {R}_{L}}{{G}_{mm}} + {C}_{m} {C}_{z} ( {R}_{L} + \frac{1}{{G}_{mm}} ) ( {R}_{1} + {R}_{z} ) ] + s [ {C}_{m} {G}_{m 2} {R}_{L} {R}_{1} + {C}_{m} ( {R}_{L} + \frac{1}{{G}_{mm}} ) + {C}_{L} {R}_{L} + {C}_{z} ( {R}_{1} + {R}_{z} ) ] + 1$$

$${D}_{s} ≅ {s}^{3} [ \frac{{C}_{L} {C}_{m} {C}_{z} {R}_{L} {R}_{1} )}{{G}_{mm}} ] + {s}^{2} [ {C}_{m} {C}_{z} {G}_{m 2} {R}_{L} {R}_{1} {R}_{z} + \frac{{C}_{L} {C}_{m} {R}_{L}}{{G}_{mm}} + {C}_{m} {C}_{z} {R}_{1} ( {R}_{L} + \frac{1}{{G}_{mm}} ) ] + s [ {C}_{m} {G}_{m 2} {R}_{L} {R}_{1} + {C}_{m} ( {R}_{L} + \frac{1}{{G}_{mm}} ) + {C}_{L} {R}_{L} + {C}_{z} {R}_{1} ] + 1 , where {R}_{Z} ≪ {R}_{1}$$

and C represents capacitance, R resistance, G transconductance, and s the complex frequency-domain parameter (s=σ+iω, where σ and ω may be any real numbers). As the load impedance increases, the frequency of higher order poles decreases. To counteract the foregoing, the frequency of the zero associated with C_{z}R_{z} also decreases as indicated by the term SC_{z}R_{z}+1 in the above transfer function.

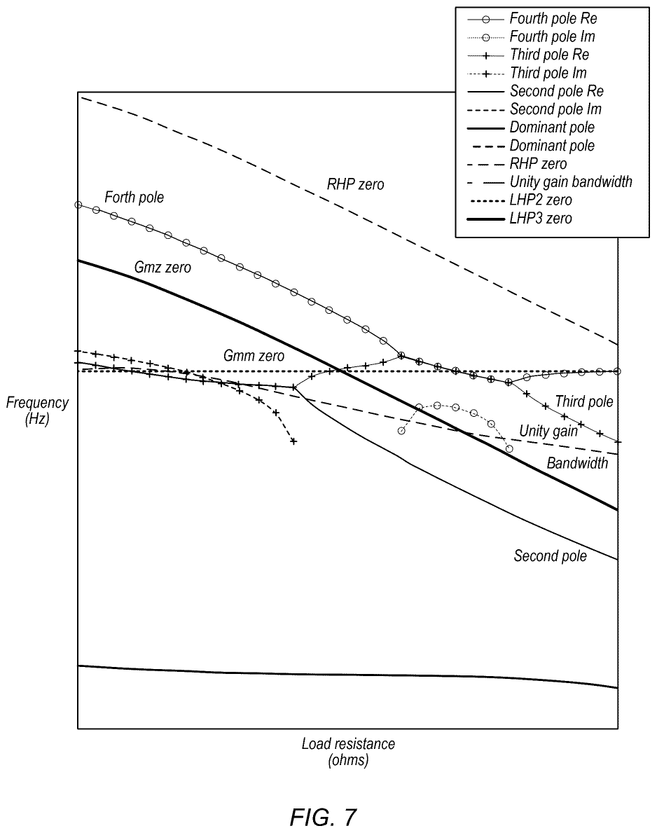

FIG. 7 is a chart illustrating example frequency response of disclosed voltage regulator circuitry, according to some embodiments. The chart depicts a frequency response that may correspond to one or both of the circuits of FIGS. 3 and 6. In particular, the chart shows that, as the impedance of load 140 increases, the complex pole pairs decrease in frequency. The zero attributable to variable resistance transistor 220 (e.g., C_{z}R_{z}) also decreases in frequency, thereby tracking a frequency response of the complex pole pair and enhancing the circuit's stability.

In the chart, G_{mz} is the ratio of the transconductance of pass transistor 230. As illustrated, for loads below a certain impedance, the second and third poles form a complex pole pair. For loads between with a larger impedance, the third and fourth poles form a complex pole pair. The right-half plane (RHP) zero is attributable to gain-drain capacitance of pass transistor 230. As illustrated, the zero attributable to the transconductance of pass transistor 230 follows a frequency response of the complex pole pairs.

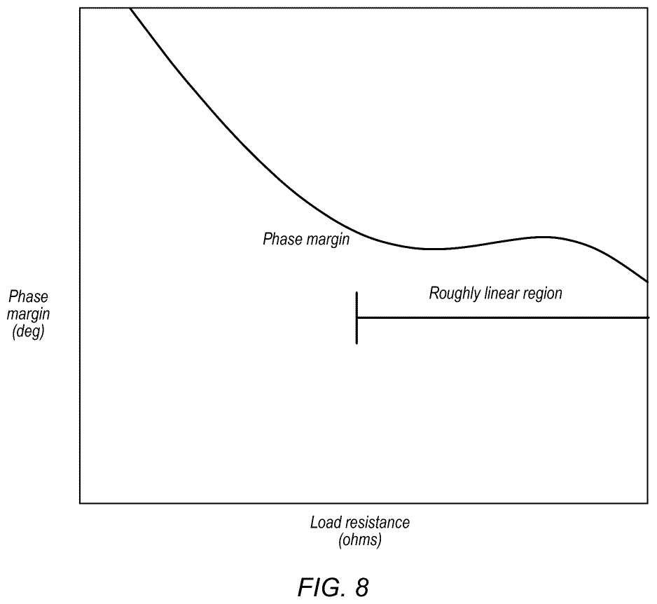

FIG. 8 is a chart illustrating example phase margin of disclosed voltage regulator circuitry, according to some embodiments. As shown, as the impedance of load 140 increases, the slope of the phase margin approaches zero, as the phase margin becomes approximately linear. This approximate linearity is attributable to the resistance of variable resistance transistor 220 tracking the impedance of load 140 such that a zero associated with the variable resistance transistor 220 follows a frequency of the complex pole pair associated with the circuits of FIGS. 3 and 6. The phase margin depicted in FIG. 8 may be greater than for traditional circuitry, such that the stability of the circuit is improved over its operating frequency range.

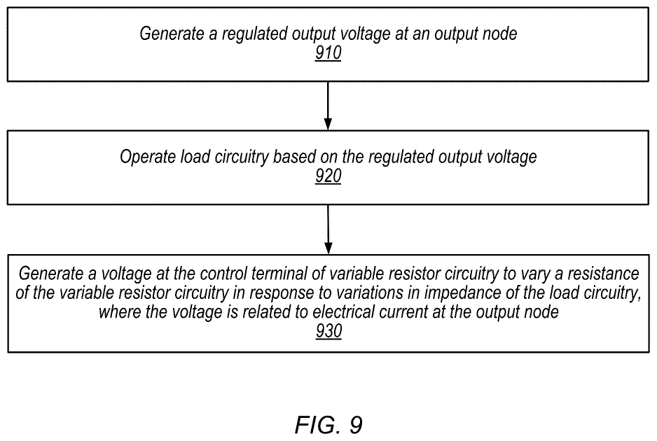

FIG. 9 is a flow diagram illustrating an example method, according to some embodiments. The illustrated may be used in conjunction with any of the computer systems, devices, elements, or components disclosed herein, among other devices. In various embodiments, some of the method elements shown may be performed concurrently, in a different order than shown, or may be omitted. Additional method elements may also be performed if desired.

At 910, in the illustrated embodiment, a computing system (e.g., pass transistor 230 of a voltage regulator) generates a regulated output voltage at an output node.

At 920, in the illustrated embodiment, load circuitry operates based on the regulated output voltage.

At 930, in the illustrated embodiment, the system (e.g., monitor circuitry) generates a voltage at a control terminal of a variable resistor circuit (e.g., 220) to vary a resistance of the variable resistor circuitry in response to variations in impedance of the load circuitry. The voltage at the control terminal is related to electrical current at the output node. In some embodiments, the monitor circuitry is the monitor circuitry is coupled to the internal node of the voltage regulator circuitry.

In some embodiments, the voltage regulator circuitry includes a pass transistor having a first terminal coupled to the output node and a control terminal connected to the internal node. In some embodiments, the variable resistor circuitry includes a variable resistance transistor having a first terminal coupled to the high supply node and a second terminal connected to the internal node via a capacitor. In some embodiments, the pass transistor and the variable resistance transistor are p-channel metal oxide semiconductor field effect transistors (P-MOSFETs), the first terminal of the pass transistor is a drain, the control terminal of the pass transistor is a gate, a second terminal of the pass transistor is coupled to the high supply node and is a source, the first terminal of the variable resistance transistor is a source, the second terminal of the variable resistance transistor is a drain, and the control terminal of the variable resistance transistor is a gate, e.g., as shown in FIG. 6.

In some embodiments, the monitor circuitry includes a current-to-voltage transistor having a first terminal coupled to the high supply node and a control terminal coupled to a control terminal of the variable resistance transistor. In some embodiments, the monitor circuitry incudes a second pass transistor having a first terminal coupled to the high supply node, and a control terminal coupled to the control terminal of the pass transistor. The second pass transistor may be configured to generate an electrical current at an output node of the second pass transistor that is proportional in magnitude to the electrical current generated by the pass transistor at the output node of the pass transistor. In some embodiments, the second pass transistor is smaller than the pass transistor, and a magnitude of the electrical current at the output node of the second pass transistor is less than a magnitude of the electrical current at the output node of the pass transistor.

In some embodiments, the monitor circuitry further includes a current-to-voltage converter transistor coupled to the second pass transistor. The current-to-voltage converter transistor may be configured to receive the electrical current from the second pass transistor and generate a voltage at a control terminal of the current-to-voltage converter transistor based on the received electrical current. The control terminal of the current-to-voltage converter transistor may be coupled to the control terminal of the variable resistance transistor.

In some embodiments, the monitor circuitry further includes a regulator transistor coupled to the second terminal of the second pass transistor, the regulator transistor having a lower threshold voltage than a threshold voltage of the second pass transistor and configured to maintain a voltage at the output node of the second pass transistor that approximates a voltage at the output node of the pass transistor. The monitor circuitry may also include a current mirror circuit coupled to a first terminal of the regulator transistor, the current mirror circuit configured to provide the electrical current generated by the second pass transistor to the current-to-voltage converter transistor.

In some embodiments, the system includes a stabilization capacitor and a filtration transistor having a first terminal coupled to the internal node and a second terminal coupled to the stabilization capacitor. The stabilization capacitor may be coupled to the output node and the filtration transistor may reject noise introduced into the output node by the high supply voltage.

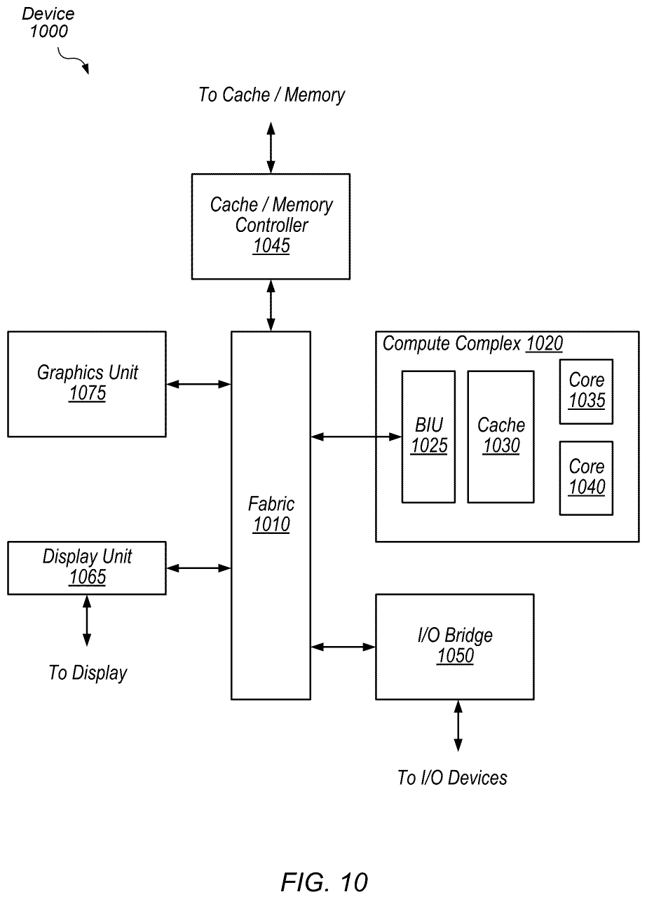

Referring now to FIG. 10, a block diagram illustrating an example embodiment of a device 1000 is shown. In some embodiments, elements of device 1000 may be included within a system on a chip. In some embodiments, device 1000 may be included in a mobile device, which may be battery-powered. Therefore, power consumption by device 1000 may be an important design consideration. In the illustrated embodiment, device 1000 includes fabric 1010, compute complex 1020, input/output (I/O) bridge 1050, cache/memory controller 1045, graphics unit 1075, and display unit 1065. In some embodiments, device 1000 may include other components (not shown) in addition to or in place of the illustrated components, such as video processor encoders and decoders, image processing or recognition elements, computer vision elements, etc.

Fabric 1010 may include various interconnects, buses, MUX's, controllers, etc., and may be configured to facilitate communication between various elements of device 1000. In some embodiments, portions of fabric 1010 may be configured to implement various different communication protocols. In other embodiments, fabric 1010 may implement a single communication protocol and elements coupled to fabric 1010 may convert from the single communication protocol to other communication protocols internally.

In the illustrated embodiment, compute complex 1020 includes bus interface unit (BIU) 1025, cache 1030, and cores 1035 and 1040. In various embodiments, compute complex 1020 may include various numbers of processors, processor cores and caches. For example, compute complex 1020 may include 1, 2, or 4 processor cores, or any other suitable number. In one embodiment, cache 1030 is a set associative L2 cache. In some embodiments, cores 1035 and 1040 may include internal instruction and data caches. In some embodiments, a coherency unit (not shown) in fabric 1010, cache 1030, or elsewhere in device 1000 may be configured to maintain coherency between various caches of device 1000. BIU 1025 may be configured to manage communication between compute complex 1020 and other elements of device 1000. Processor cores such as cores 1035 and 1040 may be configured to execute instructions of a particular instruction set architecture (ISA) which may include operating system instructions and user application instructions. These instructions may be stored in computer readable medium such as a memory coupled to memory controller 1045 discussed below.

In some embodiments, compute complex 1020 implements various disclosed fast clear techniques for blocks of data, which may improve its performance, reduce its power consumption, or some combination thereof for certain workloads.

As used herein, the term “coupled to” may indicate one or more connections between elements, and a coupling may include intervening elements. For example, in FIG. 10, graphics unit 1075 may be described as “coupled to” a memory through fabric 1010 and cache/memory controller 1045. In contrast, in the illustrated embodiment of FIG. 10, graphics unit 1075 is “directly coupled” to fabric 1010 because there are no intervening elements.

Cache/memory controller 1045 may be configured to manage transfer of data between fabric 1010 and one or more caches and memories. For example, cache/memory controller 1045 may be coupled to an L3 cache, which may in turn be coupled to a system memory. In other embodiments, cache/memory controller 1045 may be directly coupled to a memory. In some embodiments, cache/memory controller 1045 may include one or more internal caches. Memory coupled to controller 1045 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 1045 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1020 to cause the computing device to perform functionality described herein.

Graphics unit 1075 may include one or more processors, e.g., one or more graphics processing units (GPU's). Graphics unit 1075 may receive graphics-oriented instructions, such as OPENGL®, Metal, or DIRECT3D® instructions, for example. Graphics unit 1075 may execute specialized GPU instructions or perform other operations based on the received graphics-oriented instructions. Graphics unit 1075 may generally be configured to process large blocks of data in parallel and may build images in a frame buffer for output to a display, which may be included in the device or may be a separate device. Graphics unit 1075 may include transform, lighting, triangle, and rendering engines in one or more graphics processing pipelines. Graphics unit 1075 may output pixel information for display images. Graphics unit 1075, in various embodiments, may include programmable shader circuitry which may include highly parallel execution cores configured to execute graphics programs, which may include pixel tasks, vertex tasks, and compute tasks (which may or may not be graphics-related).

In some embodiments, graphics unit 1075 implements various disclosed fast clear techniques, which may improve its performance, reduce its power consumption, or some combination thereof.

Display unit 1065 may be configured to read data from a frame buffer and provide a stream of pixel values for display. Display unit 1065 may be configured as a display pipeline in some embodiments. Additionally, display unit 1065 may be configured to blend multiple frames to produce an output frame. Further, display unit 1065 may include one or more interfaces (e.g., MIPI® or embedded display port (eDP)) for coupling to a user display (e.g., a touchscreen or an external display).

I/O bridge 1050 may include various elements configured to implement: universal serial bus (USB) communications, security, audio, and low-power always-on functionality, for example. I/O bridge 1050 may also include interfaces such as pulse-width modulation (PWM), general-purpose input/output (GPIO), serial peripheral interface (SPI), and inter-integrated circuit (I2C), for example. Various types of peripherals and devices may be coupled to device 1000 via I/O bridge 1050.

In some embodiments, device 1000 includes network interface circuitry (not explicitly shown), which may be connected to fabric 1010 or I/O bridge 1050. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1000 with connectivity to various types of other devices and networks.

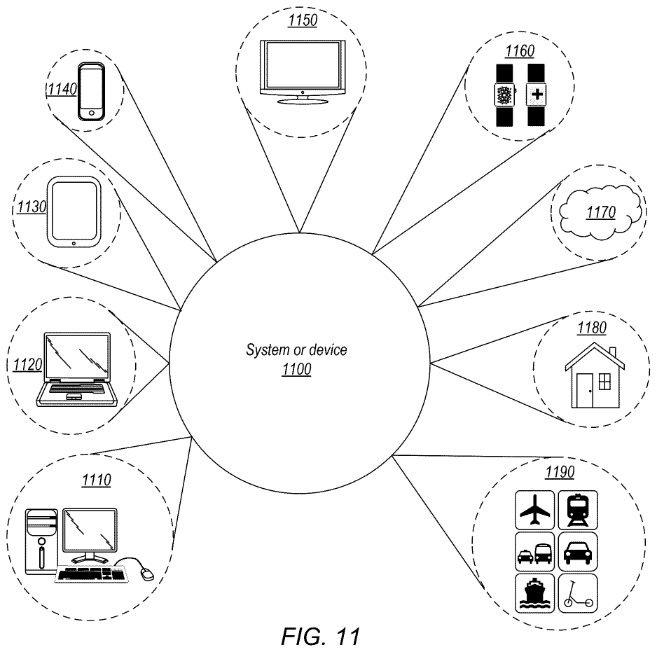

Turning now to FIG. 11, various types of systems that may include any of the circuits, devices, or system discussed above. System or device 1100, which may incorporate or otherwise utilize one or more of the techniques described herein, may be utilized in a wide range of areas. For example, system or device 1100 may be utilized as part of the hardware of systems such as a desktop computer 1110, laptop computer 1120, tablet computer 1130, cellular or mobile phone 1140, or television 1150 (or set-top box coupled to a television).

Similarly, disclosed elements may be utilized in a wearable device 1160, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1100 may also be used in various other contexts. For example, system or device 1100 may be utilized in the context of a server computer system, such as a dedicated server or on shared hardware that implements a cloud-based service 1170. Still further, system or device 1100 may be implemented in a wide range of specialized everyday devices, including devices 1180 commonly found in the home such as refrigerators, thermostats, security cameras, etc. The interconnection of such devices is often referred to as the “Internet of Things” (IoT). Elements may also be implemented in various modes of transportation. For example, system or device 1100 could be employed in the control systems, guidance systems, entertainment systems, etc. of various types of vehicles 1190.

The applications illustrated in FIG. 11 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that is recognized by a computing system configured to generate a simulation model of the hardware circuit, by a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

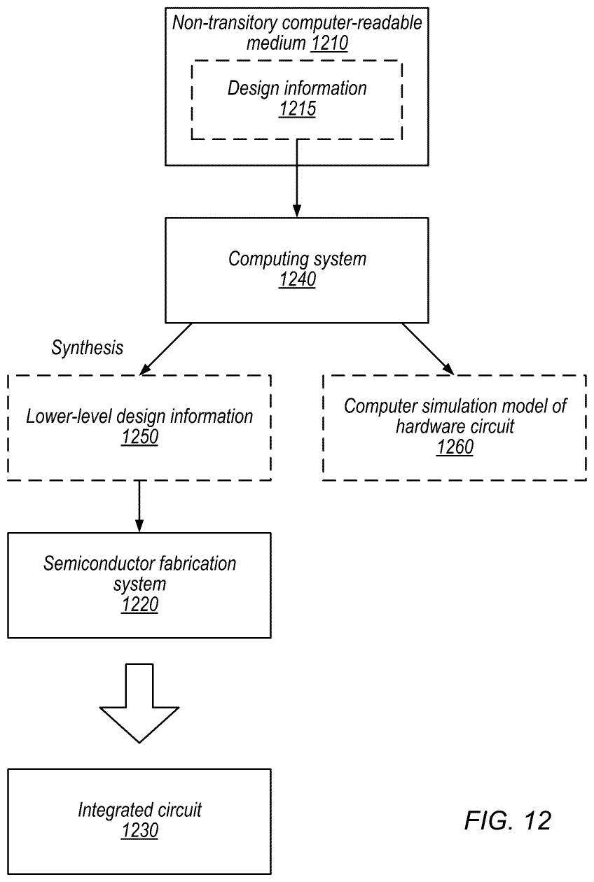

FIG. 12 is a block diagram illustrating an example non-transitory computer-readable storage medium that stores circuit design information, according to some embodiments. In the illustrated embodiment, computing system 1240 is configured to process the design information. This may include executing instructions included in the design information, interpreting instructions included in the design information, compiling, transforming, or otherwise updating the design information, etc. Therefore, the design information controls computing system 1240 (e.g., by programming computing system 1240) to perform various operations discussed below, in some embodiments.

In the illustrated example, computing system 1240 processes the design information to generate both a computer simulation model of a hardware circuit 1260 and lower-level design information 1250. In other embodiments, computing system 1240 may generate only one of these outputs, may generate other outputs based on the design information, or both. Regarding the computing simulation, computing system 1240 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1240 also processes the design information to generate lower-level design information 1250 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1250 (potentially among other inputs), semiconductor fabrication system 1220 is configured to fabricate an integrated circuit 1230 (which may correspond to functionality of the simulation model 1260). Note that computing system 1240 may generate different simulation models based on design information at various levels of description, including information 1250, 1215, and so on. The data representing design information 1250 and model 1260 may be stored on medium 1210 or on one or more other media.

In some embodiments, the lower-level design information 1250 controls (e.g., programs) the semiconductor fabrication system 1220 to fabricate the integrated circuit 1230. Thus, when processed by the fabrication system, the design information may program the fabrication system to fabricate a circuit that includes various circuitry disclosed herein.

Non-transitory computer-readable storage medium 1210, may comprise any of various appropriate types of memory devices or storage devices. Non-transitory computer-readable storage medium 1110 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1210 may include other types of non-transitory memory as well or combinations thereof. Accordingly, non-transitory computer-readable storage medium 1210 may include two or more memory media; such media may reside in different locations—for example, in different computer systems that are connected over a network.

Design information 1215 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1240, semiconductor fabrication system 1220, or both. In some embodiments, design information may also include one or more cell libraries that specify the synthesis, layout, or both of integrated circuit 1230. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1230 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1220 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1220 may also be configured to perform various testing of fabricated circuits for correct operation.

In various embodiments, integrated circuit 1230 and model 1260 are configured to operate according to a circuit design specified by design information 1215, which may include performing any of the functionality described herein. For example, integrated circuit 1230 may include any of various elements shown in FIGS. 1-6. Further, integrated circuit 1230 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1220 to fabricate integrated circuit 1230.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of. . . . W, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]-is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
voltage regulator circuitry configured to generate a regulated output voltage at an output node based on a high supply voltage at a high supply node and a low supply voltage at a low supply node;
load circuitry configured to operate based on the regulated output voltage, wherein the load circuitry has a varying impedance over a range of operating frequencies;
variable resistor circuitry coupled to the high supply node and an internal node of the voltage regulator circuitry; and
monitor circuitry, wherein the monitor circuitry is configured to:
monitor characteristics of the output node; and
generate a voltage at a control terminal of the variable resistor circuitry to vary a resistance of the variable resistor circuitry in response to variations in impedance of the load circuitry, wherein the voltage at the control terminal is related to electrical current at the output node.

2. The apparatus of claim 1, wherein the monitor circuitry is also coupled to the internal node of the voltage regulator circuitry.

3. The apparatus of claim 1, wherein:
the voltage regulator circuitry includes a pass transistor having a first terminal coupled to the output node and a control terminal connected to the internal node; and
the variable resistor circuitry includes a variable resistance transistor having a first terminal coupled to the high supply node and a second terminal connected to the internal node via a capacitor.

4. The apparatus of claim 3, wherein:
the pass transistor and the variable resistance transistor are p-channel metal oxide semiconductor field effect transistors (P-MOSFETs);
the first terminal of the pass transistor is a drain;
the control terminal of the pass transistor is a gate;
a second terminal of the pass transistor is coupled to the high supply node and is a source;
the first terminal of the variable resistance transistor is a source;
the second terminal of the variable resistance transistor is a drain; and
the control terminal of the variable resistance transistor is a gate.

5. The apparatus of claim 3, wherein the monitor circuitry includes a current-to-voltage transistor having a first terminal coupled to the high supply node and a control terminal coupled to a control terminal of the variable resistance transistor.

6. The apparatus of claim 3, wherein the monitor circuitry incudes a second pass transistor having a first terminal coupled to the high supply node, and a control terminal coupled to the control terminal of the pass transistor, and wherein the second pass transistor is configured to generate an electrical current at an output node of the second pass transistor that is proportional in magnitude to the electrical current generated by the pass transistor at the output node of the pass transistor.

7. The apparatus of claim 6, wherein the second pass transistor is smaller than the pass transistor, and wherein a magnitude of the electrical current at the output node of the second pass transistor is less than a magnitude of the electrical current at the output node of the pass transistor.

8. The apparatus of claim 6, wherein:
the monitor circuitry further includes a current-to-voltage converter transistor coupled to the second pass transistor;
the current-to-voltage converter transistor is configured to receive the electrical current from the second pass transistor and generate a voltage at a control terminal of the current-to-voltage converter transistor based on the received electrical current; and
the control terminal of the current-to-voltage converter transistor is coupled to the control terminal of the variable resistance transistor.

9. The apparatus of claim 8, wherein the monitor circuitry further includes:
a regulator transistor coupled to the second terminal of the second pass transistor, the regulator transistor having a lower threshold voltage than a threshold voltage of the second pass transistor and configured to maintain a voltage at the output node of the second pass transistor that approximates a voltage at the output node of the pass transistor; and
a current mirror circuit coupled to a first terminal of the regulator transistor, the current mirror circuit configured to provide the electrical current generated by the second pass transistor to the current-to-voltage converter transistor.

10. The apparatus of claim 1, further comprising:
a filtration transistor having a first terminal coupled to the internal node and a second terminal coupled to a stabilization capacitor; and
the stabilization capacitor, wherein the stabilization capacitor is coupled to the output node and wherein the filtration transistor is configured to reject noise introduced into the output node by the high supply voltage.

11. The apparatus of claim 1, wherein:
the voltage regulator is a multi-stage regulator;
the monitor circuitry includes an auxiliary pass transistor to a pass transistor of a driver buffer stage of the multi-stage regulator; and
the auxiliary pass transistor is configured to generate a current proportional to the electrical current at the output node.

12. A method, comprising:
generating, by voltage regulator circuitry, a regulated output voltage at an output node based on a high supply voltage at a high supply node and a low supply voltage at a low supply node;
providing, by the voltage regulator circuitry, the regulated output voltage to load circuitry coupled to the voltage regulator circuitry, wherein the load circuitry has a varying impedance and operates over a range of operating frequencies; and
generating, by monitoring circuitry that monitors characteristics of the output node, a voltage at a control terminal of variable resistor circuitry to vary a resistance of the variable resistor circuitry in response to variations in impedance of the load circuitry, wherein the voltage at the control terminal is related to electrical current at the output node.

13. The method of claim 12, further comprising:
transitioning, by the load circuitry, from a high power state to a low power state or from the low power state to the high power state, wherein the transitioning changes impedance of the load circuitry and causes a change in the electrical current at the output node.

14. The method of claim 12, wherein:
the generating the regulated output voltage includes biasing a control terminal of the voltage regulator circuitry with a biasing voltage; and
the generating the voltage at the control terminal includes:
biasing auxiliary voltage regulator circuitry of the monitoring circuitry with the biasing voltage;
receiving a second electrical current at a current mirror of the monitoring circuitry, the second electrical current having a magnitude proportional to a magnitude of the electrical current at the output node; and
converting the second electrical current to a voltage provided to the control terminal of the variable resistor circuitry.

15. The method of claim 12, wherein the variable resistor circuitry and the monitor circuitry are coupled to an internal node of the voltage regulator circuitry.

16. The method of claim 12, further comprising rejecting, by stability control circuitry, noise from the high supply voltage from leaking into the regulated output voltage.

17. An apparatus, comprising:
first voltage regulator circuitry configured to generate a first electrical current at a first output node coupled to load circuitry, wherein the load circuitry is configured to operate based on the first electrical current and having a varying impedance over a range of operating frequencies;
variable resistor circuitry;
monitor circuitry configured to monitor characteristics of the first output node, wherein the monitor circuitry includes:
second voltage regulator circuitry having a control terminal coupled to a control terminal of the first voltage regulator circuitry, the second voltage regulator circuitry configured to generate a second electrical current at a second output node, wherein the second electrical current is proportional in magnitude to the first electrical current; and
current-to-voltage converter circuitry configured to convert the second electrical current into a control voltage at a control terminal of the variable resistor circuitry to vary a resistance of the variable resistor circuitry in response to variations in impedance of the load circuitry.

18. The apparatus of claim 17, wherein the variable resistor circuitry is coupled to a capacitor, and wherein a terminal of the capacitor is coupled to the control terminal of the first voltage regulator circuitry.

19. The apparatus of claim 17, further comprising stability control circuitry, wherein the stability control circuitry includes:
a transistor having a first terminal coupled to the control terminal of the first voltage regulator circuitry and a second terminal coupled to a capacitor, wherein the capacitor has a terminal coupled to the first output node.

20. The apparatus of claim 17, wherein the load circuitry is configured to transition from a high power state to a low power state or from the low power state to the high power state, and wherein the varying impedance is attributable to the transition.
